(19) United States
(12) Patent Application Publication
(10) Pub. No.: US 2013/0086785 A1
(43) Pub. Date: Apr. 11, 2013

(54) HYBRID REPAIR PLUGS AND REPAIR METHODS INCORPORATING THE SAME

(71) Applicants: Yan Cui, Greer, SC (US); Srikanth Chandrudu Kottilingam, Simpsonville, SC (US); Brian Lee Tollison, Honea Path, SC (US); Dechao Lin, Greer, SC (US); David Edward Schick, Greenville, SC (US)

(72) Inventors: Yan Cui, Greer, SC (US); Srikanth Chandrudu Kottilingam, Simpsonville, SC (US); Brian Lee Tollison, Honea Path, SC (US); Dechao Lin, Greer, SC (US); David Edward Schick, Greenville, SC (US)

(21) Appl. No.: 13/267,273

(22) Filed: Oct. 6, 2011

(51) Int. Cl. B23P 6/04; B32B 15/01

(52) U.S. Cl. 29/402.18; 428/615; 428/668

(57) ABSTRACT

Hybrid repair plugs include an alloy core and a sintered preform shell at least partially surrounding the alloy core, wherein the sintered preform shell includes a mixture comprising a base alloy comprising about 30 weight percent to about 90 weight percent of the mixture and a second alloy including a sufficient amount of a melting point depressant to have a lower melting temperature than the base alloy.

### BACKGROUND OF THE INVENTION

The subject matter disclosed herein relates to filling openings in substrates that operate at high temperatures and, more specifically, to filling holes in substrates of hot gas path components using hybrid repair plugs.

Components of gas turbines, such as buckets (blades), nozzles (vanes), and other hot gas path components can comprise nickel, cobalt or iron-base superalloys with mechanical properties suitable for turbine operating temperatures and conditions. Because the efficiency of a gas turbine is dependent in part on its operating temperatures, there is a demand for components, and particularly turbine buckets and nozzles, that are capable of withstanding increasingly higher temperatures. As the maximum local metal temperature of a superalloy component approaches the melting temperature of the superalloy, forced air cooling may become necessary. For this reason, airfoils of gas turbine buckets and nozzles can include complex cooling schemes in which air is forced through internal cooling passages within the airfoil and then discharged through cooling holes at the airfoil surface.

Buckets and nozzles formed by casting processes may require cores to define the internal cooling passages. During the casting process, shifting of the cores may be prevented by supporting the cores within the mold using quartz rods or similar means. The rods create openings (through-holes) in the casting that must be securely closed or plugged to prevent the loss of cooling air through these holes and ensure proper air flow levels through the intended cooling holes of the casting. In some cases, welding is not practical for closing or filling holes resulting from casting operations due to costs, poor fusion weldability of the material, inaccessibility with welding equipment, and other restrictions arising from the configuration of the component. Furthermore, welding techniques can involve the application of localized heat energy that produces a fusion zone and a base metal heat affected zone (HAZ) that may be prone to liquation and strain age cracking.

Alternative to welding, brazing techniques may generally be performed at temperatures lower than the melting point of the base metals and, when performed appropriately, not be susceptible to cracking. Brazing performed on superalloy castings can involve the use of braze materials in pliable forms such as pastes, putties, slurries, and tapes. Brazing techniques using sintered preforms may also be used for applying wear resistant materials on bucket surfaces and for surface buildup.

Brazing pastes, putties, slurries, and tapes may generally contain metal particles in a binder that adheres the metal particles together and to the surface(s) being brazed and then burns off during the brazing operation. The metal particles can comprise a mixture of two or more different alloys, one of which contains a melting point depressant (for example, boron or silicon) to achieve a lower melting point. During brazing, only the lower melting particles may melt to form a liquid that fills voids between the higher melting particles and, on solidification, bonds the high melting particles together and to the substrate material. However, the use of such pliable braze materials can include various difficulties including consistently using optimal quantities of the braze material, accurately placing the braze material, and accurately shaping and sizing the braze material for the area being brazed. Because of their pliability, which includes the ability to flow in the case of slurries, other shortcomings can include the difficulty of filling large openings and surfaces where the braze material is likely to flow away from the area being brazed. Still other shortcomings can include low densities and excessive porosity and voids, resulting in poor mechanical properties for the resulting brazement.

Sintered brazing preforms may also be initially prepared to contain a binder, which is removed during a sintering operation performed prior to brazing, resulting in the metal particles being sintered together (fused or agglomerated) to yield a rigid preform. However, because of their rigidity, sintered preforms may generally be limited to surface repairs.

Accordingly, alternative hybrid repair plugs and repair methods incorporating the same would be welcome in the art.

### BRIEF DESCRIPTION OF THE INVENTION

In one embodiment, a hybrid repair plug for filling an opening in a substrate is provided. The hybrid repair plug includes an alloy core and a sintered preform shell at least partially surrounding the alloy core. The sintered preform shell includes a mixture comprising a base alloy comprising about 30 weight percent to about 90 weight percent of the mixture and a second alloy including a sufficient amount of a melting point depressant to have a lower melting temperature than the base alloy.

In another embodiment, a repaired substrate comprising a filled in opening is provided. The repaired substrate includes a substrate comprising an opening and a hybrid repair plug disposed within the opening. The hybrid repair plug includes an alloy core and a sintered preform shell at least partially surrounding the alloy core. The sintered preform shell comprises a mixture comprising a base alloy comprising about 30 weight percent to about 90 weight percent of the mixture and a second alloy comprising a sufficient amount of a melting point depressant to have a lower melting temperature than the base alloy.

In yet another embodiment, a repair method for filling an opening in a substrate is provided. The repair method includes disposing a hybrid repair plug in the opening. The hybrid repair plug includes an alloy core and a sintered preform shell at least partially surrounding the alloy core, wherein the sintered preform shell includes a mixture comprising a base alloy comprising about 30 weight percent to about 90 weight percent of the mixture and a second alloy comprising a sufficient amount of a melting point depressant to have a lower melting temperature than the base alloy. The repair method further includes heating the hybrid repair plug in the opening to bond the hybrid repair plug to the substrate.

These and additional features provided by the embodiments discussed herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 is a perspective view of a hybrid repair plug according to one or more embodiments shown or described herein;

FIG. 2 is a cross-sectional view of the hybrid repair plug illustrated in FIG. 1 according to one or more embodiments shown or described herein;

FIG. 3 is a perspective view of an alloy core according to one or more embodiments shown or described herein;

FIG. 4 is a cross-sectional view of the alloy core illustrated in FIG. 3 according to one or more embodiments shown or described herein;

FIG. 5 is a perspective view of a sintered preform shell according to one or more embodiments shown or described herein;

FIG. 6 is a cross-sectional view of the sintered preform shell illustrated in FIG. 5 according to one or more embodiments shown or described herein;

FIG. 7 is a side view of a hybrid repair plug according to one or more embodiments shown or described herein;

FIG. 8 is a perspective view of a hybrid repair plug according to one or more embodiments shown or described herein;

FIG. 9 is a side view of a repaired substrate according to one or more embodiments shown or described herein;

FIG. 10 is a top view of the repaired substrate illustrated in FIG. 9 according to one or more embodiments shown or described herein;

FIG. 11 is an exemplary repair method according to one or more embodiments shown or described herein;

FIG. 12 is micrograph of a hybrid repair plug interface in a repaired substrate along the transverse direction;

FIG. 13 is a more detailed micrograph of a section of the hybrid repair plug interface in the repaired substrate of FIG. 12;

FIG. 14 is micrograph of a hybrid repair plug interface in a repaired substrate along the longitudinal direction; and

FIG. 15 is a more detailed micrograph of a section of the hybrid repair plug interface in the repaired substrate of FIG. 14.

### DETAILED DESCRIPTION OF THE INVENTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Hybrid repair plugs disclosed herein may be used to fill openings in substrates such as hot gas path components used in gas turbines. The hybrid repair plugs can generally comprise an alloy core and a sintered preform shell at least partially surrounding the alloy core. The hybrid repair plug can be shaped to provide a close fit with the opening and then heated to bond with the substrate. By utilizing the sintered preform shell to separate the alloy core of the hybrid repair plug and the substrate, the alloy core and the substrate can comprise common (i.e., substantially similar or the same) materials such that the repaired substrate can have more uniform properties. Hybrid repair plugs, repaired substrates comprising hybrid repair plugs, and repair methods using hybrid repair plugs will now be described in more detail herein.

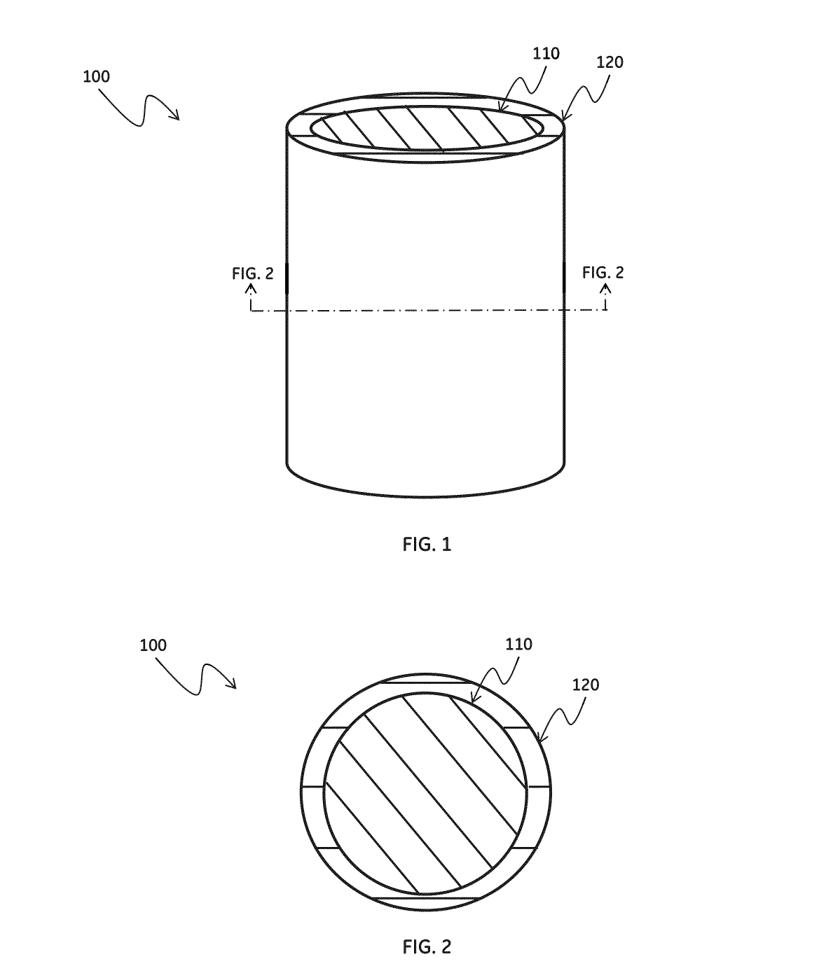

Referring now to FIGS. 1-4, as discussed above hybrid repair plugs 100 generally comprise an alloy core 110 and a sintered preform shell 120. The alloy core 110 can comprise any alloy potentially used in high temperature applications such as alloys used in hot gas path components for gas turbines (e.g., buckets, vanes, nozzles, etc.). In some embodiments, the alloy core 110 can comprise nickel-based superalloys such as René N4, René N5, René 108, GTD-111®, GTD-222®, GTD-444® and IN-738. René N4, René N5, René 108, GTD-111®, GTD-222® and GTD-444® comprise gamma prime-strengthened nickel-based superalloys whose compositions are reported in various literature, including U.S. Pat. Nos. 4,810,467, 5,154,884, 5,399,313, 6,0746,02, 6,416,596, 6,428,637, and others. The nominal composition of IN-738 is reported as, by weight, about 16% chromium, 8.5% cobalt, 1.75% molybdenum, 2.6% tungsten, 1.75% tantalum, 0.9% niobium, 3.4% aluminum, 3.4% titanium, 0.10% zirconium, 0.01% boron, 0.17% carbon, the balance nickel and impurities. In some embodiments, the alloy core 110 can comprise cobalt-based superalloys such as FSX-414. The nominal composition of FSX-414 is, by weight, about 29.5% chromium, 10.5% nickel, 7% tungsten, up to 2% iron, 0.25% carbon, and 0.012% boron, the balance cobalt and incidental impurities. Moreover, in some embodiments the alloy core 110 can comprise a single crystal. In some embodiments, the alloy core 110 can comprise a hardface material suitable for wear applications. It should be appreciated that while specific materials have been listed herein for the composition of the alloy core 110, these listed materials are exemplary only and non-limiting and other alloys may alternatively or additionally be used.

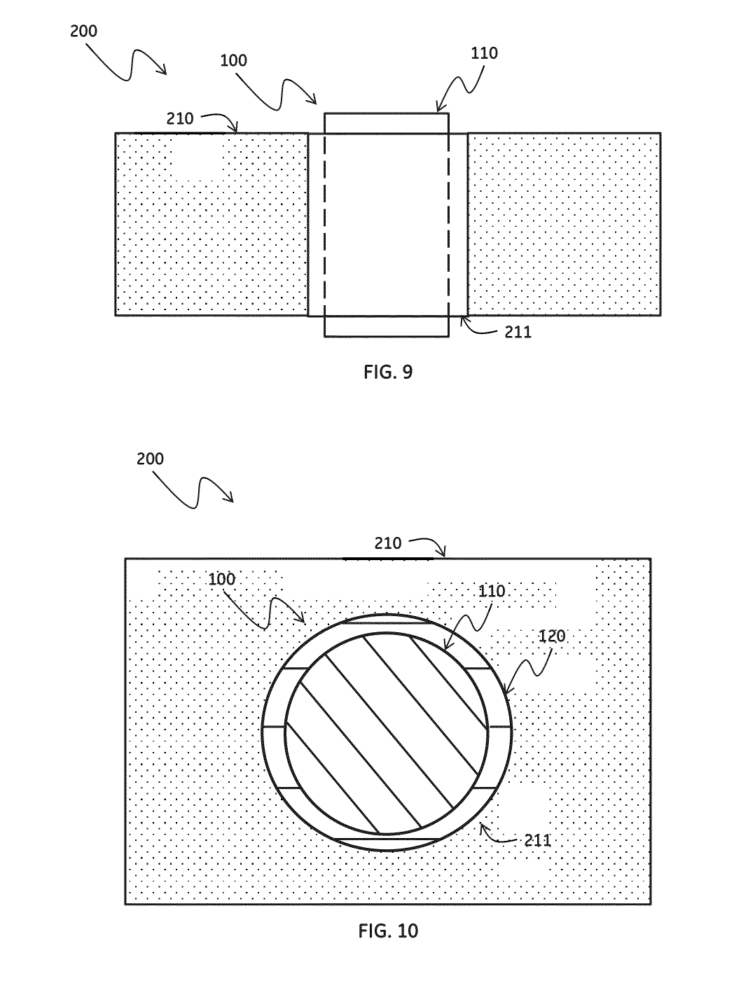

The alloy core 110 can comprise any size and shape that can be at least partially surrounded by the sintered preform shell 120 and disposed in an opening of a substrate as will become appreciated herein. For example, in some embodiments, such as those illustrated in FIGS. 1-4, the alloy core 110 can comprise a cylinder shape. Such embodiments may allow for the subsequent insertion into relatively cylinder-shaped openings in a substrate such as a hole that may be present in hot gas path components of gas turbines (e.g., buckets, vanes, nozzles, etc.) as a result of manufacturing, repair or other acts that result in material removal. In other embodiments, the alloy core 110 may comprise other shapes such as rectangular rods, pyramids, spheres, or any other suitable geometrical or non-geometrical shape (or combinations thereof), or any other shape customized to compliment a unique hole pattern. In some embodiments the alloy core 110 may have a substantially uniform width. In other embodiments, such as that illustrated in FIG. 8, the alloy core 110 may comprise a tapered profile such that the diameter of the end to be inserted into the substrate is smaller than the diameter of the end to face the exterior of the substrate. As will become appreciated herein, such embodiments may help ensure a relatively tight fit between the hybrid repair plug 100 and the surface of the substrate (element 210 in FIGS. 9 and 10).

Moreover, the alloy core 110 may include other physical features (e.g., holes, protrusions, contours, etc.) to aid in the manufacturing, assembly and/or operations. For example, in some embodiments the alloy core 110 can include one or more holes drilled into it prior to brazing. The one or more holes drilled before brazing can prevent additional setup for machining post-brazing as may be required for the manufacturing, assembly and/or operations.

Referring now to FIGS. 1-2 and 5-6, as discussed above, the hybrid repair plug 100 further comprises a sintered preform shell 120 that at least partially surrounds the alloy core 110. The sintered preform shell 120 comprises a mixture of particles comprising a base alloy and a second alloy that have been sintered together at a temperature below their melting points to form an agglomerate and somewhat porous mass. Suitable particle size ranges for the powder particles include 150 mesh, or even 325 mesh or smaller to promote rapid sintering of the particles and minimize porosity in the sintered preform shell 120 to about 90 volume percent or less. In some embodiments, the density of the sintered preform shell 120 has a density of 90% or better. In even some embodiments, the sintered preform shell 120 has a density of 95% or better. As discussed below, the sintered perform shell 120 can be subjected to hot isostatic pressing (HIP) or vacuum/inert atmosphere pressing to promote higher densities.

The base alloy of the sintered preform shell 120 can comprise any composition similar to or the same as the alloy core 110 and/or the substrate (element 210 in FIGS. 9 and 10) to promote common physical properties between the original part and the repaired area. For example, in some embodiments, the base alloy can comprise nickel-based superalloys such as René N4, René N5, René 108, GTD-111®, GTD-222®, GTD-444®, IN-738 and MarM 247 or cobalt-based superalloys such as FSX-414 as discussed above. In some embodiments, the properties for the base alloy include chemical and metallurgical compatibility with the alloy core 110 and/or the substrate (element 210 in FIGS. 9 and 10), high fatigue strength, low tendency for cracking, oxidation resistance and/or machinability.

In some embodiments, the base alloy may comprise a melting point of within about 25° C. of the melting temperature of the alloy core 110 and/or the substrate (element 210 in FIGS. 9 and 10). In some embodiments, the base alloy may comprise a compositional range of, by weight, about 2.5 to 11% cobalt, 7 to 9% chromium, 3.5 to 11% tungsten, 4.5 to 8% aluminum, 2.5 to 6% tantalum, 0.02 to 1.2% titanium, 0.1 to 1.8% hafnium, 0.1 to 0.8% molybdenum, 0.01 to 0.17% carbon, up to 0.08% zirconium, up to 0.60 silicon, up to 2.0 rhenium, the balance nickel and incidental impurities. In even some embodiments, the base alloy may comprise a compositional range of, by weight, about 9 to 11% cobalt, 8 to 8.8% chromium, 9.5 to 10.5% tungsten, 5.3 to 5.7% aluminum, 2.8 to 2.3% tantalum, 0.9 to 1.2% titanium, 1.2 to 1.6% hafnium, 0.5 to 0.8% molybdenum, 0.13 to 0.17% carbon, 0.03 to 0.08% zirconium, the balance nickel and incidental impurities. It should be appreciated that while specific materials and compositions have been listed herein for the composition of the base alloy of the sintered preform shell 120, these listed materials and compositions are exemplary only and non-limiting and other alloys may alternatively or additionally be used. Furthermore, it should be appreciated that the particular composition of the base alloy for the sintered preform shell 120 may depend on the composition(s) of the alloy core 110 and/or the substrate (element 210 in FIGS. 9 and 10).

As discussed above, the sintered preform shell 120 further comprises a second alloy. The second alloy may also have a composition similar to the alloy core 110 and/or the substrate (element 210 in FIGS. 9 and 10) but further contain a melting point depressant to promote sintering of the base alloy and the second alloy particles and enable bonding of the sintered preform shell 120 to both the alloy core 110 and the substrate (element 210 in FIGS. 9 and 10) at temperatures below the melting point of the alloy core 110 and the substrate (element 210 in FIGS. 9 and 10). For example, in some embodiments the melting point depressant can comprise boron and/or silicon.

In some embodiments, the second alloy may comprise a melting point of about 25° C. to about 50° C. below the grain growth or incipient melting temperature of the alloy core 110 and/or the substrate (element 210 in FIGS. 9 and 10). Such embodiments may better preserve the desired microstructure of the alloy core 110 and/or the substrate (element 210 in FIGS. 9 and 10) during the heating process. In some embodiments, the second alloy may comprise a compositional range of, by weight, about 9 to 10% cobalt, 11 to 16% chromium, 3 to 4% aluminum, 2.25 to 2.75% tantalum, 1.5 to 3.0% boron, up to 5% silicon, up to 1.0% yttrium, the balance nickel and incidental impurities. For example, in some embodiments the second alloy may comprise commercially available Amdry DF4B nickel brazing alloy. It should also be appreciated that while specific materials and compositions have been listed herein for the composition of the second alloy of the sintered preform shell 120, these listed materials and compositions are exemplary only and non-limiting and other alloys may alternatively or additionally be used. Furthermore, it should be appreciated that the particular composition of the second alloy for the sintered preform shell 120 may depend on the composition(s) of the alloy core 110 and/or the substrate (element 210 in FIGS. 9 and 10).

The sintered preform shell 120 can comprise any relative amounts of the base alloy and the second alloy that are sufficient to provide enough melting point depressant to ensure wetting and bonding (e.g., diffusion/brazing bonding) of the particles of the base alloy and the second alloy to each other and to the walls of the alloy core 110 and the substrate (element 210 in FIGS. 9 and 10). For example, in some embodiments the second alloy can comprise at least about 10 weight percent of the sintered preform shell 120. In some embodiments the second alloy can comprise no more than 70 weight percent of the sintered preform shell 120. Such embodiments may provide a sufficient amount of melting point depressant while limiting potential reduction of the mechanical and environmental properties of the subsequent heating. Furthermore, in these embodiments, the base alloy can comprise the remainder of the sintered preform shell 120 (e.g., between about 30 weight percent and about 70 weight percent of the sintered preform shell 120). In even some embodiments, the particles of the base alloy can comprise about 40 weight percent to about 70 weight percent of the sintered preform shell 120 with the balance of the composition comprising particles of the second alloy. It should be appreciated that while specific relative ranges of the base alloy and the second alloy have been presented herein, these ranges are exemplary only and non-limiting and any other relative compositions may also be realized such that a sufficient amount of melting point depressant is provided as discussed above.

Aside from the particles of the base alloy and the second alloy, no other constituents are required within the sintered preform shell 120. However, in some embodiments, a binder may be initially blended with the particles of the base alloy and the second alloy to form a cohesive mass that can be more readily shaped prior to sintering. In such embodiments, the binder can include, for example, a binder commercially available under the name NICROBRAZ-S from the Wall Colmonoy Corporation. Other potentially suitable binders include NICROBRAZ 320, VITTA GEL from Vitta Corporation, and others including adhesives commercially available from Cotronics Corporation, all of which may volatilize cleanly during sintering.

The sintered preform shell 120 may be formed by mixing the powder particles of the base alloy (i.e., base alloy particles) and the second alloy (i.e., second alloy particles) by any suitable means such as stirring, shaking, rotating, folding or the like or combinations thereof. After mixing, the mixture may be combined with the binder (i.e., to form a combined powder mixture) and cast into shapes (i.e., to form a compacted preform), during and/or after which the binder can be burned off. The compacted preform may then be placed in a non-oxidizing (vacuum or inert gas) atmosphere furnace for the sintering operation, during which the powder particles of the base alloy and the second alloy undergo sintering to yield the sintered preform shell 120 with good structural strength and low porosity. Suitable sintering temperatures may at least in part depend on the particular compositions of the particles of the base alloy and the second alloy. For example, in some embodiments, the sintering temperature may be in a range of about 1010° C. to about 1280° C. In some embodiments, following sintering, the sintered preform shell 120 can be HIPed or vacuum pressed to achieve densities greater than 95%.

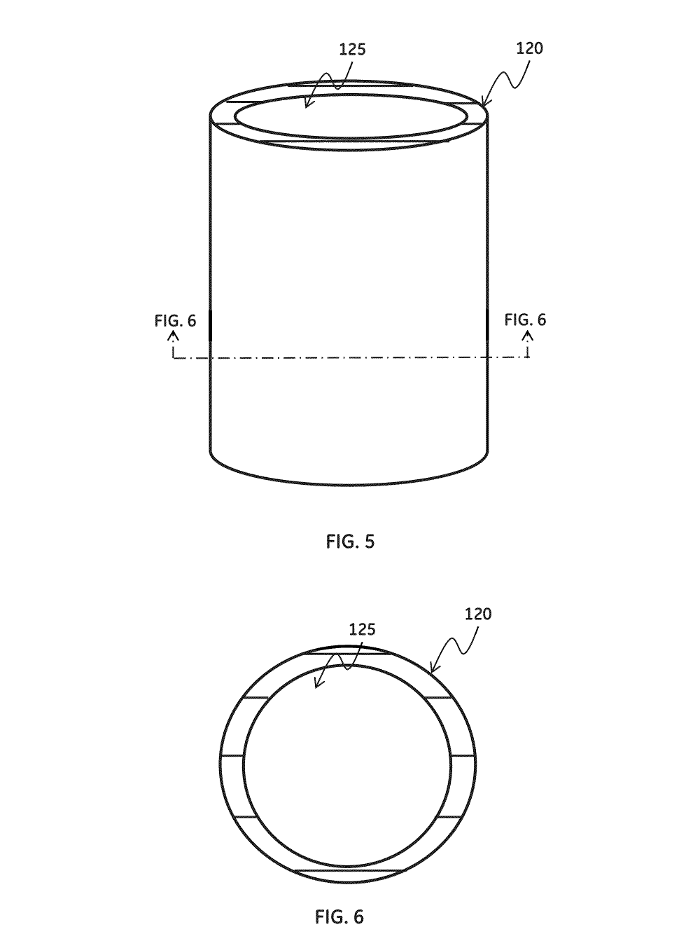

Referring now to FIGS. 1-2 and 5-6, the sintered preform shell 120 can comprise any size and shape that at least partially surrounds the alloy core 110 so that the overall hybrid repair plug 100 may be inserted into and bonded with the substrate (element 210 in FIGS. 9 and 10). For example, in some embodiments, the sintered preform shell 120 can comprise a tubular shape with a hollow cavity 125 as best illustrated in FIGS. 5 and 6. As illustrated in FIGS. 1 and 2, such embodiments can allow for the sintered preform shell 120 to be slipped around the periphery of a cylinder shaped alloy core 110. The sintered preform shell 120 can alternatively or additional comprise any other shape to at least partially surround an alloy core 110 of any particular shape (such as those discussed above).

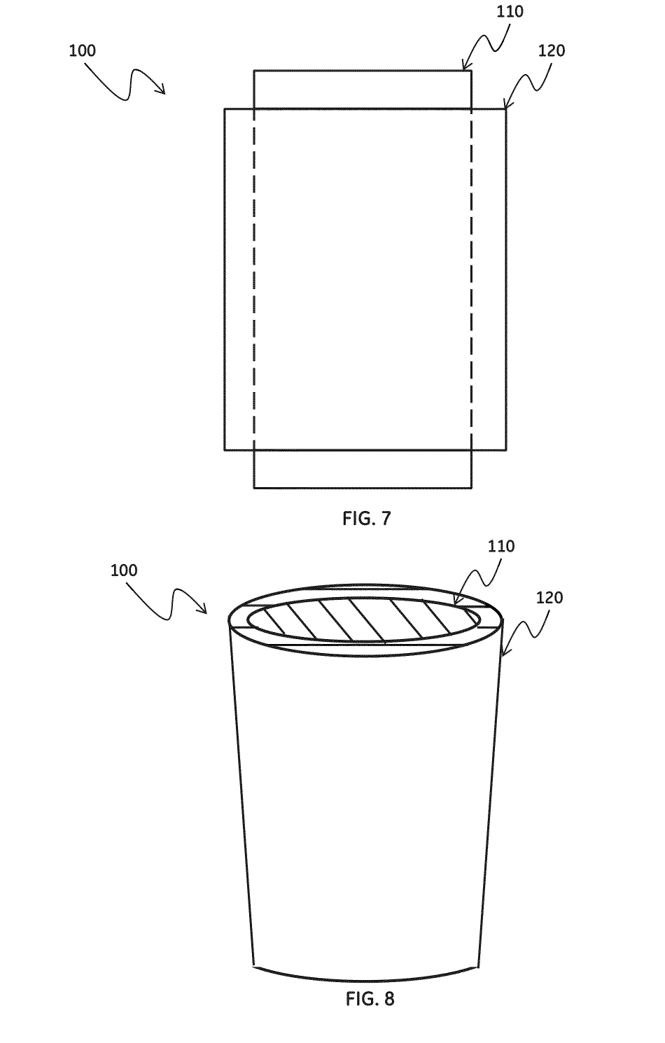

For example, referring to FIG. 7, in some embodiments the sintered preform shell 120 can comprise a height that is less than the height of the alloy core 110. As such, the alloy core 110 will extend past the sintered preform shell 120 when combined into the hybrid repair plug 100. Such embodiments may allow for the additional height of the alloy core 110 to act as a riser when heating and bonding the hybrid repair plug 100 to a substrate. Alternatively, in some embodiments the sintered preform shell 120 can comprise a height that is greater than the height of the alloy core 110. As such, the sintered preform shell 120 will extend past the alloy core 110 when combined into the hybrid repair plug 100. Such embodiments may allow for the additional height of the sintered preform shell 120 to act as a riser when heating and bonding the hybrid repair plug 100 to a substrate.

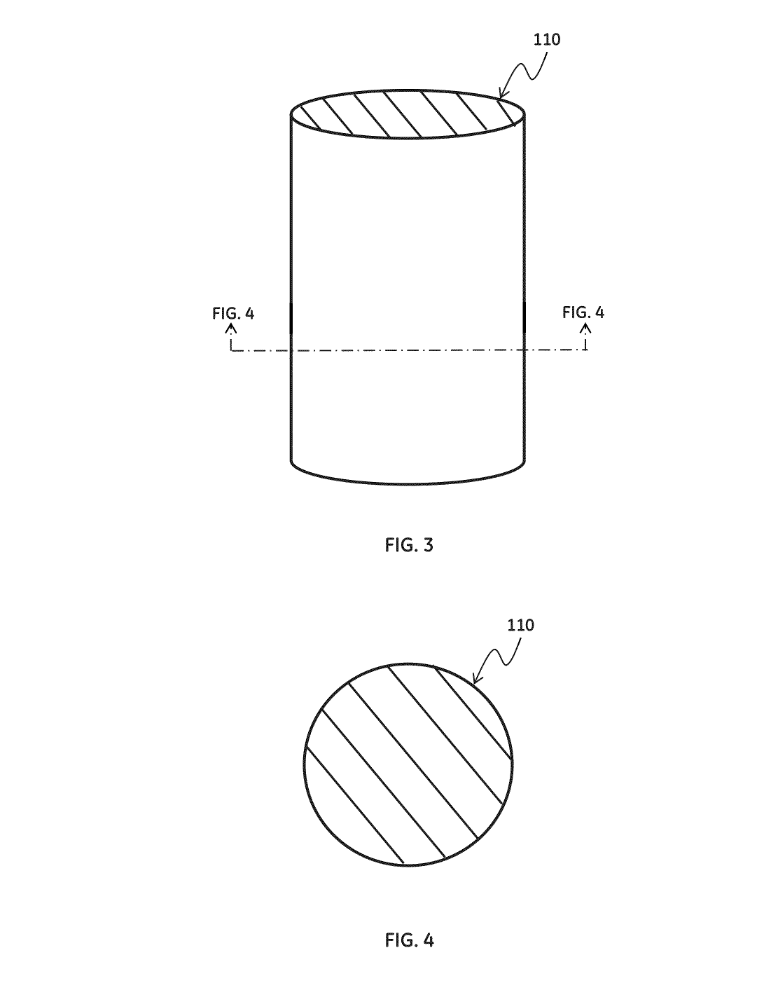

Referring now to FIGS. 1-2 and 7-10, the sintered preform shell 120 can be placed around the alloy core 110 to form the hybrid repair plug 100. The hybrid repair plug 100 can thereby comprise any size and shape that allows it to be disposed in an opening 211 in a substrate 210 for repair. For example, where the alloy core 110 comprises a cylinder shape (as illustrated in FIGS. 3 and 4) and the sintered preform shell 120 comprises a tubular shape (as illustrated in FIGS. 5 and 6), the hybrid repair plug 100 can be utilized for filling a relatively cylinder-shaped opening 211 in a substrate 210 such as holes that may be present in hot gas path components of gas turbines (e.g., buckets, vanes, nozzles, etc.) as a result of manufacturing, repair or other acts that result in material removal. Moreover, the overall hybrid repair plug 100 may comprise a substantially uniform width (as illustrated in FIGS. 1-2), or may alternatively comprise a varying width such as a tapered profile (as illustrated in FIG. 8).

Because of their rigidity, the alloy core 110 and the sintered preform shell 120 can be sized and shaped such that they form a tight fit with one another as well as with the opening 211 of the substrate 210 to achieve a proper joint gap at the heating temperature. For example, in some embodiments the clearance between the sintered preform shell 120 and both the alloy core 110 and/or the walls of the opening 211 of the substrate 210 may not be greater than about 200 micrometers, about 25 to about 150 micrometers, or about 25 to about 75 micrometers. In some embodiments, the alloy core 110 and the sintered preform shell 120 can be sized and shaped such that it can be press-fit with one another and/or the substrate 210.

In some embodiments, the alloy core 110 and/or the sintered preform shell 120 may be originally formed into the final shape to be utilized in the hybrid repair plug 100. In some embodiments, the alloy core 110 and/or the sintered preform shell 120 may be initially formed in an oversize condition relative to the other component of the hybrid repair plug 100 and/or the opening 211 of a substrate 210 to allow for machining of the alloy core 110 and/or the sintered preform shell 120 to a size and shape that closely fits within and completely fills the opening 211. As such, prior to machining, the alloy core 110 and/or the sintered preform shell 120 can have a height of greater than the through-hole (axial) dimension of the opening 211 and a cross-section larger and different from the opening 211, and can then be sintered and/or machined to have essentially any dimensions (width and height) and cross-sectional shape (e.g., a simple closed curve, simple polygon, and combinations thereof) necessary to fill the opening 211. Suitable methods for machining the alloy core 110 and/or the sintered preform shell 120 include turning, milling, grinding, cutting, EDM, ECM, waterjet, laser or the like. In some embodiments, machining may be performed so as not to form a recast layer on the surface of the sintered preform shell 120 caused by melting and resolidification of the powders of the base alloy and the second alloy. Alternatively, any recast layer can be removed following machining and before the heating operation.

Referring now to FIGS. 9 and 10, the hybrid repair plug 100 can be inserted into an opening 211 in a substrate 210 and subsequently bonded to the substrate 210 via heat and vacuum to form a repaired substrate 200 comprising the now integral hybrid repair plug 100.

The substrate 210 can comprise any alloy potentially used in high temperature applications and can comprise any high temperature application component such as hot gas path components for gas turbines (e.g., buckets, vanes, nozzles, etc.). The substrate 210 can comprise the same or substantially similar composition as the alloy core 110 and/or the base alloy of the sintered preform shell 120 discussed above. Such embodiments can provide a repaired substrate 200 that has more uniform properties across the repaired area. For example, in some embodiments, the substrate 210 can comprise nickel-based superalloys such as René N4, René N5, René 108, GTD-111®, GTD-222®, GTD-444® and IN-738 as discussed above. In some embodiments, the substrate 210 can comprise cobalt-based superalloys such as FSX-414 as also discussed above. Moreover, in some embodiments the substrate 210 can comprise a single crystal. It should be appreciated that while specific materials have been listed herein for the composition of the substrate 210, these listed materials are exemplary only and non-limiting and other alloys may alternatively or additionally be used.

The opening 211 in the substrate 210 can comprise any type of opening 211 that may need to be filled in substrates that operate at high temperatures. For example, in some embodiments the opening 211 may comprise blind holes, through-holes, and cavities in castings such as hot gas path components of gas turbines. In some embodiments, the opening 211 may comprise a void left from when material was removed around a damaged section to create a more uniform opening 211 that is easier to fill. It should be appreciated that the opening 211 may comprise any other void of material suitable for being filled by a hybrid repair plug 100 as appreciated herein.

As discussed above, the hybrid repair plug 100 (and more specifically the alloy core 110 and the sintered preform shell 120) can be sized and shaped to form a tight fit with the substrate 210 when disposed in the opening 211. In some embodiments, the hybrid repair plug 100 may form a flush profile with the surface of the substrate 210 such that neither the alloy core 110 or the sintered preform shell 120 protrude from the substrate 210. However, in some embodiments, one or more portions of the hybrid repair plug 100 may protrude from the substrate 210 when the hybrid repair plug 100 is initially disposed into the opening 211 of the substrate 210. For example, the alloy core 110 may protrude from the substrate 210 (as illustrated in FIG. 9), the sintered preform shell 120 may protrude from the substrate, or both the alloy core 110 and the sintered preform shell 120 may protrude from the substrate 210. In such embodiments, the resulting protrusions may be left as is, or may be machined or otherwise adjusted before or after being heated so that the hybrid repair plug 100 no longer protrudes from the substrate 210. Moreover, as opposed to protruding from the substrate 210, in some embodiments one or more portions of the hybrid repair plug 100 may alternatively or additionally be recessed below the surface of the substrate 210.

Once the hybrid repair plug 100 is disposed in the opening 211 of the substrate 210 (as illustrated in FIGS. 9 and 10), the hybrid repair plug 100 and the substrate 210 can be heated within a non-oxidizing (vacuum or inert gas) atmosphere to a temperature capable of melting the particles comprising the second alloy (i.e., the lower melting particles) of the sintered preform shell 120, such as within a range of about 2050° F. to about 2336° F. (about 1120° C. to about 1280° C.) (depending on composition) for a period of about 10 to about 60 minutes. The second alloy particles can then melt and wet the particles of the base alloy and the walls of both the alloy core 110 and the opening 211 thereby creating a two-phase mixture that alloys together. In some embodiments, a small amount of additional low melt constituent material can be placed between the sintered preform shell 120 and the walls of the opening 211 and/or the alloy core 110 to increase brazement quality. Thereafter, the substrate 210 and the hybrid repair plug 100 are cooled below the solidus temperature of the sintered preform shell 120 to solidify the mixture and form the superalloy brazement. The brazement can then undergo a heat treatment at a temperature of about 1975° F. to about 2100° F. (about 1080° C. to about 1150° C.) for a duration of about thirty minutes to about four hours to further interdiffuse the particles of the base alloy and the second alloy as well as the alloy of the substrate 210 and the alloy core 110. After heat treatment, any excess material in the brazement can be removed by grinding or any other suitable method.

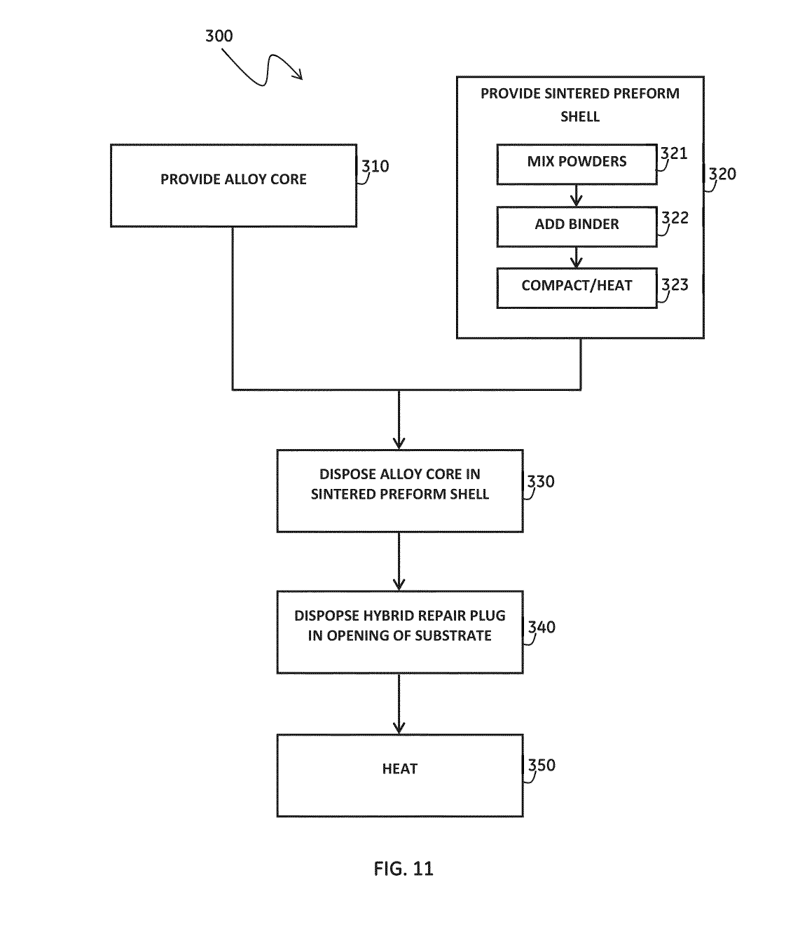

Referring now to FIG. 11, an exemplary repair method 300 for filling an opening in a substrate is provided using a hybrid repair plug (element 100 in FIGS. 1-10) as disclosed herein. The repair method 300 first comprises providing an alloy core (element 110 in FIGS. 1-10) in step 310. The alloy core 110 can be manufactured, machined or otherwise provided such that it can be combined with the sintered preform shell (element 120 in FIGS. 1-10) to form the hybrid repair plug (element 100 in FIGS. 1-10). As discussed above, providing the alloy core 110 may comprise selecting a material composition based on the composition of the substrate (element 210 in FIGS. 9 and 10) and/or the base alloy in the sintered preform shell 120.

The repair method 300 further comprises providing a sintered preform shell (element 120 in FIGS. 1-10) in step 320. Providing the sintered preform shell 120 can comprise mixing the particles from the base alloy and the second alloy as discussed above in step 321. Optionally, in some embodiments, providing the sintered preform shell 120 may further comprise adding a binder to the mixture in step 322. Finally, the mixture of the base alloy and the second alloy (and potentially a binder) is compacted and/or heated in step 323 to form the sintered preform shell 120. It should be appreciated that providing an alloy core 110 in step 310 and providing the sintered preform shell 120 in step 320 may occur simultaneously or in any order relative to one another.

After the alloy core 110 and the sintered preform shell 120 are provided in steps 310 and 320 respectively, the alloy core 110 is disposed in the sintered preform shell 120 in step 330 to form the hybrid repair plug (element 100 in FIGS. 1-10). Disposing the alloy core 110 in the sintered preform shell 120 may be accomplished through any suitable mechanism such as mechanically pushing the alloy core 110 into the hollow cavity (element 125 in FIGS. 5 and 6) of the sintered preform shell 120. As discussed above, depending on the desired relative configuration of the alloy core 110 and sintered preform shell 120, the alloy core 110 can be disposed in the sintered preform shell 120 such that the alloy core 110 extends beyond the sintered preform shell 120, is recessed within the sintered preform shell 120, is substantially flush with the sintered preform shell 120 or combinations thereof. Furthermore, in some embodiments the alloy core 110 may remain in the sintered preform shell 120 via mechanical interlocking such as due to a tight fit configuration.

After the hybrid repair plug 100 is formed in step 330 by inserting the alloy core 110 in the sintered preform shell 120, the hybrid repair plug 100 is disposed in the opening (element 211 in FIGS. 9 and 10) of the substrate 210. Similar to disposing the alloy core 110 in the sintered preform shell 120 in step 330, disposing the hybrid repair plug 100 in the opening 211 of the substrate 210 may be accomplished through any suitable mechanism such as mechanically pushing the hybrid repair plug 100 into the opening 211. Moreover, depending on the desired relative configuration of the hybrid repair plug 100 and the substrate 210, the hybrid repair plug 100 can be disposed in the opening 211 such that either the alloy core 110 and/or the sintered preform shell 120 extend beyond the substrate 210, are recessed within the substrate 210, are substantially flush with the substrate 210 or combinations thereof.

Finally, after the hybrid repair plug 100 is disposed in the opening 211 of the substrate 210 in step 340, the combined parts (i.e., the hybrid repair plug 100 and the substrate 210) are heated in step 350 to bond the hybrid repair plug 100 to the substrate 210 to produce a repaired substrate (element 200 in FIGS. 9 and 10). As discussed above, the hybrid repair plug 100 and substrate 210 can be heated using a non-oxidizing (vacuum or inert gas) atmosphere to a temperature capable of melting the particles comprising the second alloy. The heating may occur in one linear ramp up to the desired temperature, may occur using multiple temperature plateaus, may occur using dynamic target temperatures (such as based on the melting status of the second alloy in the sintered preform shell 120), or may occur using any other heating temperature profile suitable to melt the particles comprising the second alloy to wet the particles of the base alloy and the walls of both the alloy core 110 and the opening 211 thereby creating a two-phase mixture that alloys together. Depending on the configuration of the hybrid repair plug 100 relative to the substrate 210, the hybrid repair plug 100 and/or substrate 210 can then undergo any other necessary finishing steps such as machining, grinding, brazing, and welding or otherwise adjusting the hybrid repair plug 100 to become substantially flush with the substrate 210.

### EXAMPLE

A hybrid repair plug as disclosed herein was manufactured and disposed into an opening of a substrate and subsequently heated to examine the bonding interface at the repair site. Both the alloy core of the hybrid repair plug and the substrate itself consisted of commercially available René 108 nickel-based super alloy. The sintered preform shell consisted of a base alloy of commercially available MarM 247 and a second alloy of commercially available Amdry DF4B nickel brazing alloy. The base alloy and the second alloy were mixed at a 50:50 ratio by weight.

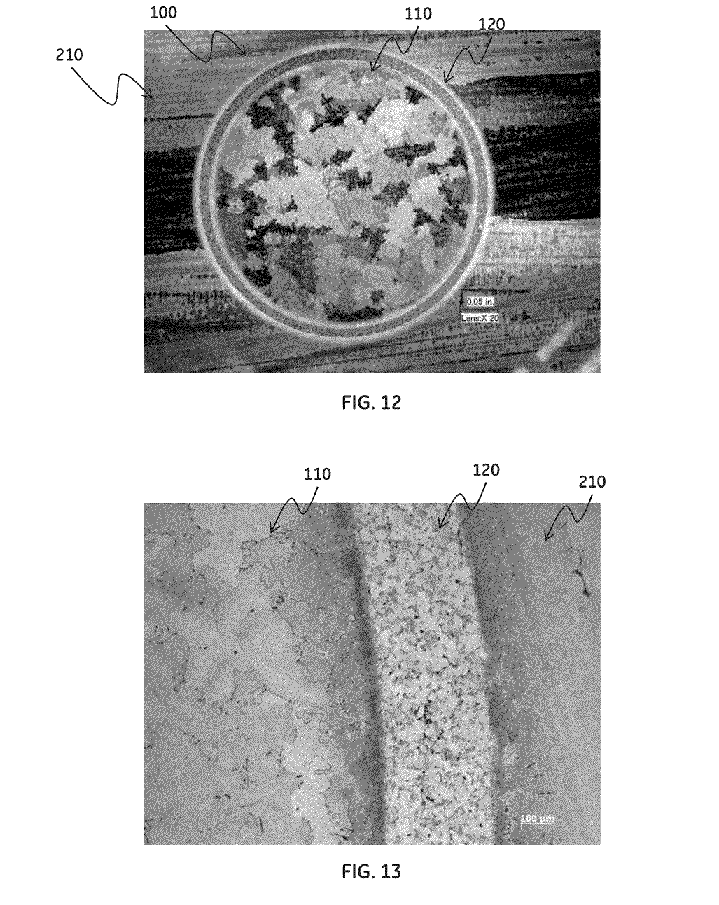

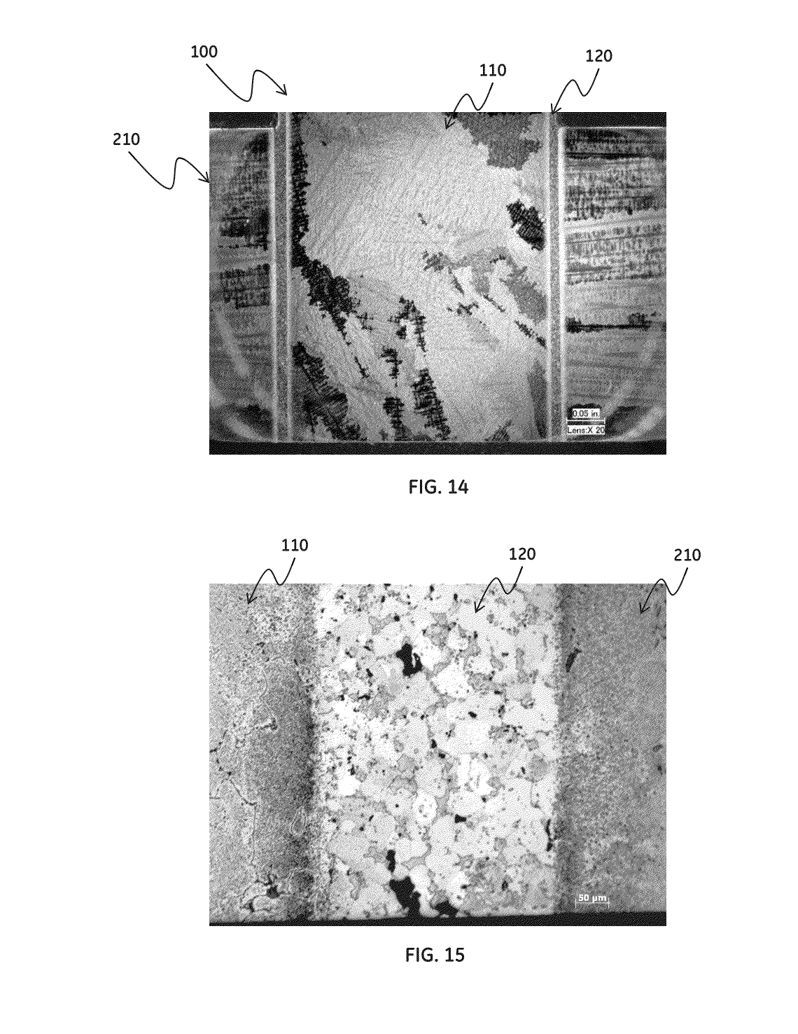

The hybrid repair plug was then inserted into the opening of the substrate for bonding. A first brazing temperature of 2175° F. (˜1190.6° C.) was used for 12 minutes followed by a diffusion cycle of 1950° F. (˜1065.6° C.) for 2 hours. Referring now to FIGS. 12-15, optical micrographs were taken along the transverse (FIGS. 12 and 13) and the longitudinal (FIGS. 14 and 15) directions. Solid metallurgical bonding was observed between the alloy core 110 and the sintered preform shell 120 as well as between the substrate 210 and the sintered preform shell 120. Moreover, no cracking or lack of brazing was observed.

It should now be appreciated that hybrid repair plugs can be used to repair various openings in substrates such as hot gas path components used in gas turbines. By utilizing the sintered preform shell to separate the alloy core of the hybrid repair plug and the substrate, the alloy core and the substrate can comprise the same or substantially similar material such that the repaired substrate can have more uniform properties. The use of such hybrid repair plugs disclosed herein can thereby allow for the repair of various openings including blind holes, through-holes, and cavities in hot gas path components of gas turbines with less shrinkage and more consistent mechanical properties when compared to welding, brazing and the like.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A hybrid repair plug for filling an opening in a substrate, the hybrid repair plug comprising:
an alloy core; and
a sintered preform shell at least partially surrounding the alloy core, wherein the sintered preform shell comprises a mixture comprising a base alloy comprising about 30 weight percent to about 90 weight percent of the mixture and a second alloy comprising a sufficient amount of a melting point depressant to have a lower melting temperature than the base alloy.

2. The hybrid repair plug of claim 1, wherein the alloy core and the substrate share a common composition.

3. The hybrid repair plug of claim 1, wherein the alloy core comprises a nickel- or cobalt-based alloy.

4. The hybrid repair plug of claim 1, wherein the sintered preform shell is formed by combining base alloy particles and second alloy particles with a binder to form a combined powder mixture, compacting the combined powder mixture to form a compacted preform, and heating the compacted preform to remove the binder and form the sintered preform shell.

5. The hybrid repair plug of claim 1, wherein the sintered preform shell has a density of at least 90% of theoretical.

6. The hybrid repair plug of claim 1, wherein the base alloy and second alloy are mixed together at a weight ratio of about 30:70 to about 90:10, respectively.

7. The hybrid repair plug of claim 1, wherein an alloy core height is greater than a sintered preform shell height such that at least a portion of the alloy core extends beyond the sintered preform shell.

8. The hybrid repair plug of claim 1, wherein an alloy core height is less than a sintered preform shell height such that at least a portion of the sintered preform shell extends beyond the alloy core.

9. The hybrid repair plug of claim 1, wherein the hybrid repair plug comprises a tapered profile.

10. The hybrid repair plug of claim 1, wherein the hybrid repair plug comprises a cylinder.

11. The hybrid repair plug of claim 1, wherein the hybrid repair plug comprises a cross-sectional profile to achieve a clearance of less than or equal to 200 micrometers with the opening.

12. A repaired substrate comprising a filled in opening, the repaired substrate comprising:
a substrate comprising an opening; and
a hybrid repair plug disposed within the opening, wherein the hybrid repair plug comprises:
an alloy core; and
a sintered preform shell at least partially surrounding the alloy core, wherein the sintered preform shell comprises a mixture comprising a base alloy comprising about 30 weight percent to about 90 weight percent of the mixture and a second alloy comprising a sufficient amount of a melting point depressant to have a lower melting temperature than the base alloy.

13. The repaired substrate of claim 12, wherein the substrate comprises a hot gas path component of a gas turbine.

14. The repaired substrate of claim 12, wherein the alloy core and the substrate share a common composition.

15. The repaired substrate of claim 12, wherein the sintered preform shell is formed by combining base alloy particles and second alloy particles with a binder to form a combined powder mixture, compacting the combined powder mixture to form a compacted preform, and heating the compacted preform to remove the binder and form the sintered preform shell.

16. The repaired substrate of claim 12, wherein the alloy core comprises a cylinder shape and the sintered preform shell comprises a tubular shape.

17. A repair method for filling an opening in a substrate, the repair method comprising:
disposing a hybrid repair plug in the opening, wherein the hybrid repair plug comprises an alloy core and a sintered preform shell at least partially surrounding the alloy core, wherein the sintered preform shell comprises a mixture comprising a base alloy comprising about 30 weight percent to about 90 weight percent of the mixture and a second alloy comprising a sufficient amount of a melting point depressant to have a lower melting temperature than the base alloy; and
heating the hybrid repair plug in the opening to bond the hybrid repair plug to the substrate.

18. The repair method of claim 17, wherein the hybrid repair plug is formed by providing the alloy plug, producing the sintered preform shell, and disposing the alloy plug in the sintered preform shell.

19. The repair method of claim 17, wherein producing the sintered preform shell comprises combining base alloy particles and second alloy particles with a binder to form a combined powder mixture, compacting the combined powder mixture to form a compacted preform, and heating the compacted preform to remove the binder and form the sintered preform shell.

20. The repair method of claim 17, wherein the hybrid repair plug comprises a cross-sectional profile to achieve a clearance of less than or equal to 200 micrometers with the opening prior to heating.
